(19) United States
(12) Patent Application Publication
(10) Pub. No.: US 2007/0203884 A1
(43) Pub. Date: Aug. 30, 2007

(54) System and method for obtaining file information and data locations

(76) Inventors: Tony Nichols, Erie, CO (US); Michael Burtscher, Longmont, CO (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/363,819

(22) Filed: Feb. 28, 2006

(51) Int. Cl. G06F 17/30

(52) U.S. Cl. 707/2

(57) ABSTRACT

A system and method for gathering information about files stored is described. In one embodiment the method includes identifying a starting location of a file table of the data storage device. The file table includes an entry for the file table and entries for other files stored on the data storage device. The method also includes accessing a data attribute within the entry for the file table, which includes pointers to other locations where portions of the file table are stored on the data storage device. The pointers to the other locations are utilized to locate an entry in the file table for each of the other files, and attribute information for at least one attribute of each of the other files is retrieved from the entries for the other files.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to computer system management. In particular, but not by way of limitation, the present invention relates to systems and methods for controlling pestware or malware.

### BACKGROUND OF THE INVENTION

Personal computers and business computers are continually attacked by trojans, spyware, and adware, collectively referred to as “malware” or “pestware.” These types of programs generally act to gather information about a person or organization—often without the person or organization's knowledge. Some pestware is highly malicious. Other pestware is non-malicious but may cause issues with privacy or system performance. And yet other pestware is actual beneficial or wanted by the user. Wanted pestware is sometimes not characterized as “pestware” or “spyware.” But, unless specified otherwise, “pestware” as used herein refers to any program that collects and/or reports information about a person or an organization and any “watcher processes” related to the pestware.

Software is available to detect pestware, but known software typically utilizes operating system (OS) API calls to retrieve and analyze file information stored in a data storage device (e.g., disk). This process of iteratively using OS API calls, however, is frequently a time consuming process, and as a consequence, users must wait a substantial amount of time to find out the results of a storage device scan. Even worse, some users elect not to perform a scan because they do not want to, or cannot, wait for a scan to be completed.

In addition to the amount of time required for typical software to detect pestware, there are other problems as well. Current and future pestware, for example, incorporates techniques that make the pestware difficult to identify, remove, or even to detect. These techniques, and likely future improvements to them, rely on patches, hooks and yet-to-be-discovered methods for modifying the behavior of the operating system itself. Such techniques render current detection tools ineffective by intercepting and altering the results of operating system API queries.

Although present devices are functional, they are not sufficiently accurate or otherwise satisfactory. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one embodiment, the invention may be characterized as a system and method for accessing file information from a data storage device. In this embodiment the method includes identifying a starting location of a file table that includes an entry for the file table and identifying entries for other files stored on the data storage device. In addition, the method in this embodiment includes accessing a data attribute within the entry for the file table that includes pointers to other locations where portions of the file table are stored on the data storage device and locating, utilizing the pointers to the other locations, an entry in the file table for each of the other files. Attribute information is then retrieved for each of the other files from corresponding entries in the file table for each of the other files.

In another embodiment, the invention may be characterized as a system for retrieving information about files stored on a data storage device of a computer. The system in this embodiment includes a file access module configured to identify, utilizing a file table of the files on the data storage device, locations where the file table is stored on the data storage device so as to enable attribute information for the files to be retrieved. In addition, the system includes a file information aggregator in communication with the file access module that is configured to organize and store the attribute information in an executable memory of the computer so as to enable the attribute information for the files to be analyzed.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram of a computer that is protected in accordance with several embodiments of the present invention;

FIG. 2 is flowchart depicting a method in accordance with many embodiments of the present invention; and

FIG. 3 is a partial and exploded view of one embodiment of the file storage device of FIG. 1.

### DETAILED DESCRIPTION

In accordance with several embodiments, the present invention is directed to a system and method for retrieving file information from a file storage device (e.g., hard drive) of a computer in a relatively quick and accurate manner for further analysis. In many embodiments for example, a file table of the file storage device is directly accessed to identify where on the storage device the file table is located and to retrieve information from the file table about other files on storage device. In this way, the time consuming and pestware-susceptible process of utilizing an operating system of the computer to access file information is avoided.

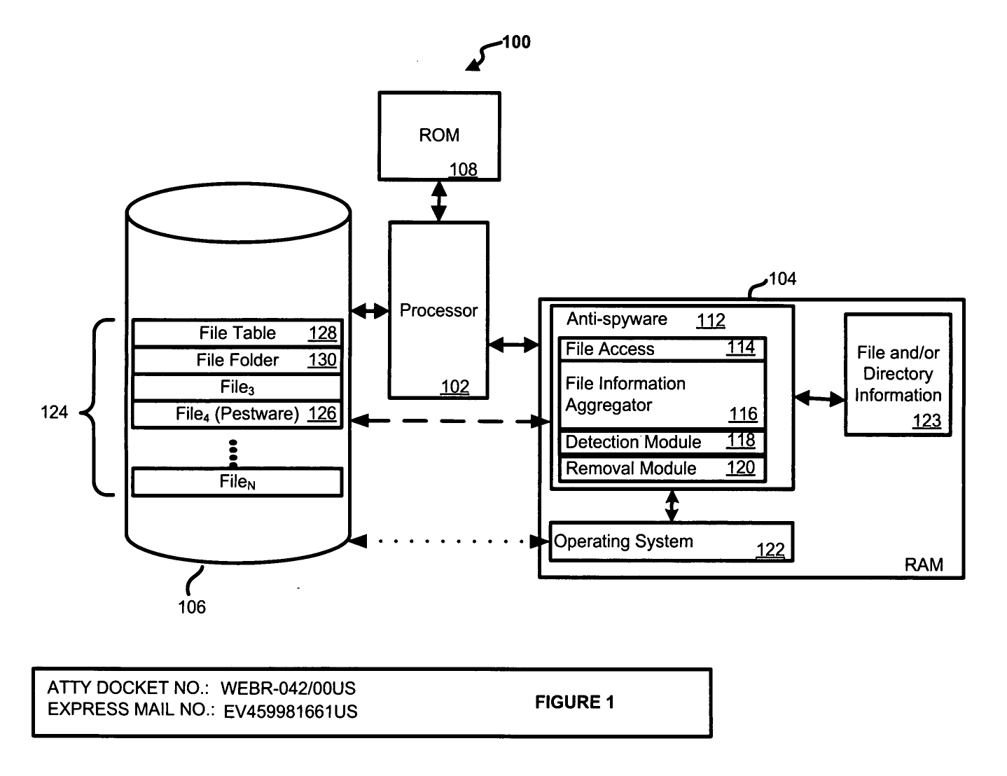

Referring now to the drawings, where like or similar elements are designated with identical reference numerals throughout the several views, and referring in particular to FIG. 1, shown is a block diagram 100 of a computer that is protected in accordance with one implementation of the present invention. The term “computer” is used herein to refer to any type of computer system, including personal computers, handheld computers, servers, firewalls, etc. This implementation includes a processor 102 coupled to memory 104 (e.g., random access memory (RAM)), a file storage device 106 and ROM 108.

As shown, the storage device 106 provides storage for a collection of N files 124, which includes a pestware file 126, a file table 128 and a file folder 130 among other files. The storage device 106 is described herein in several implementations as hard disk drive for convenience, but this is certainly not required, and one of ordinary skill in the art will recognize that other storage media may be utilized without departing from the scope of the present invention. In addition, one of ordinary skill in the art will recognize that the storage device 106, which is depicted for convenience as a single storage device, may be realized by multiple (e.g., distributed) storage devices.

The file table 128 in this embodiment is a file that includes an entry (also referred to herein as a record) for each of the files 124 on the data storage device 106 including the file table 128 itself and each of the other files. Each entry (not shown) in the file table 128 includes a set of attributes (also referred to herein as attribute information), which includes information about the corresponding file (e.g., file name(s), creation date, last-modified date, file type, alternate data streams, security information and pointers to data locations (also referred to herein as data runs). In one embodiment, as described further herein, the file table 128 is a Master File Table (MFT), which is organized in accordance with a new technology file system (NTFS) sold under the trade name of Microsoft Corp., but this is certainly not required.

In the exemplary embodiment, in addition to the file table 128 and N files 124, folders (e.g., the file folder 130), are stored on the storage device 106 as files that have corresponding entries in the file table 128. The entries for folders include index attributes that contain or point to an index of the files and subfolders within that folder.

As shown, an anti-spyware application 112 in the exemplary embodiment includes a file access module 114, a file information aggregator 116, a detection module 118 and a removal module 120, which are implemented in software and are executed from the memory 104 by the processor 102. In addition, an operating system 122 is depicted as running from memory 104 and file information 123 is shown residing in memory 104.

The software 112 can be configured to operate on personal computers (e.g., handheld, notebook or desktop), servers or any device capable of processing instructions embodied in executable code. Moreover, one of ordinary skill in the art will recognize that alternative embodiments, which implement one or more components (e.g., the anti-spyware 112) in hardware, are well within the scope of the present invention.

In the present embodiment, the operating system 122 is not limited to any particular type of operating system and may be operating systems provided by Microsoft Corp. under the trade name WINDOWS (e.g., WINDOWS 2000, WINDOWS XP, and WINDOWS NT). Additionally, the operating system may be an open source operating system such operating systems distributed under the LINUX trade name. For convenience, however, embodiments of the present invention are generally described herein with relation to WINDOWS-based systems. Those of skill in the art can easily adapt these implementations for other types of operating systems or computer systems.

In accordance with several embodiments of the present invention, the file access module 114 accesses the file table 128 directly (i.e., without using file or directory API calls of the operating system 122) to locate attribute information for each of the files, and the file information aggregator 116 collects and places the attribute information in executable memory so as to generate the file information 123, which resides in memory 104.

In one embodiment, for example, the file information aggregator 116 builds, by accessing each entry of the file table 128, a file structure for an entire volume of files on the storage device 106. In this way, every file and its path may be resolved to ensure a file is properly identified, and that the file can be properly removed, if desired and/or necessary. Additional information about directly accessing (e.g., without using OS API calls) a storage device and removing locked files is found in U.S. application Ser. No. 11/145,593, Attorney Docket No. WEBR-009/00US, entitled “System and Method for Neutralizing Locked Pestware Files,” which is incorporated herein by reference in its entirety

Beneficially, by retrieving the attributes directly from the file table 128, a large amount of information about the files 124 is obtainable with relatively little access of the storage device 106, which substantially decreases the amount of time to build a file and directory structure of the storage device 106 relative to known techniques. As a comparison, for example, retrieving attributes of files directly from an MFT in and NTFS system, in accordance with many embodiments of the present invention, enables the file and directly structure to be assembled up to four times faster than by relying on Find First and Find Next calls, which are typically utilized in connection with a WINDOWS operating system.

Moreover, in addition to substantially increasing the rate at which file attribute information is retrieved, the exemplary embodiment also circumvents particular varieties of pestware (e.g., rootkits), which are known to patch, hook, or replace system calls with versions that hide information about the pestware.

Once the file attribute information 123 is assembled, in many embodiments, it is then analyzed to assess whether there are pestware files (e.g., the pestware file 126) among the N files. In the exemplary embodiment depicted in FIG. 1, for example, the detection module 118 utilizes the file information 123 to locate and retrieve at least a portion of the data (e.g., 500 Bytes) in each of the N files and compares the data retrieved from each file against known pestware signatures. Additional information about comparing file data with pestware signatures is found in application Ser. No. 10/956,578, Attorney Docket No. WEBR-002/00US, entitled System and Method for Monitoring Network Communications for Pestware, which is incorporated herein by reference.

In addition to comparing file data against pestware definitions, in some embodiments, other pestware-related analysis of the attribute information 123 is carried out including analysis of the file names relative to known pestware names. In addition, an analysis of locations of the stored files, is also compared against known pestware activity.

Moreover, in some embodiments, alternate data stream attribute information is collected and analyzed to identify whether there are alternate data streams associated with any of the files 124 that are known to be pestware data streams. It has been found that alternate data streams provide an avenue for pestware to tack on to file types that are not typically associated with pestware such as directories and text files. Advantageously, in many embodiments, directly accessing the file table 128 enables the alternate data stream attribute information to be retrieved and analyzed to determine whether the alternate data stream is a pestware related process.

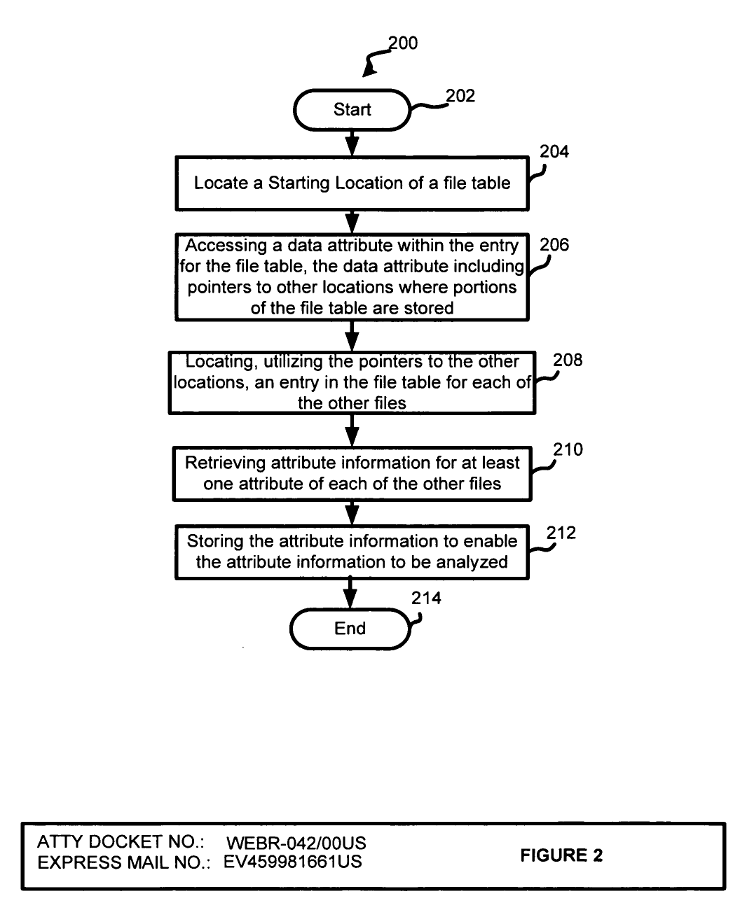

Referring next to FIG. 2, shown is a flowchart depicting a method for accessing information about files stored on a file storage device (e.g., the file storage device 106) in accordance with several embodiments of the present invention. As shown, a starting location of a file table (e.g., the file table 128) is initially located and a data attribute within an entry for the file table is accessed to determine where on the file storage device the file table is located (Blocks 200-206).

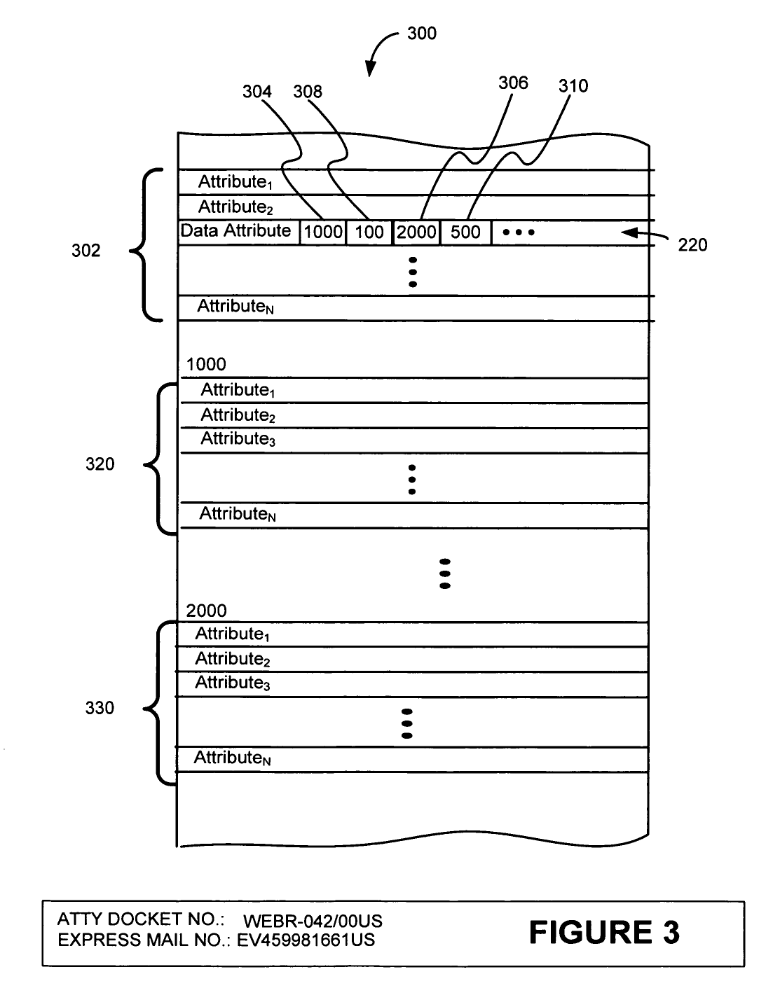

Referring briefly to FIG. 3, shown is a partial and exploded view of one embodiment of the file storage device 106 shown in FIG. 1, which in this embodiment is organized in accordance with an NTFS file system. As shown, the file storage device 300 includes fragmented portions 302, 320, 330 of a master file table (MFT). In this embodiment, the starting location of the MFT is located by reading cluster-zero of the storage device 300 (not shown), and the first entry 302 in the master file table 300 is, by default, the entry for the master file table 300 itself.

As shown, within the entry 302 for the master file table is a data attribute 220, which includes pointers (also referred to as data runs) 304, 306 to other locations of the MFT where entries 320, 330 for other files on the storage device reside. In addition, the data attribute 220 includes indicators 308, 310 of the number of contiguous clusters occupied by each data run 304, 306 of the MFT.

Referring again to FIG. 2, once the pointers to the other locations on the data storage device where the file table is stored are accessed, an entry in the file table for each of the other files is located (Block 208) and attribute information for at least one attribute of each of the other files is retrieved (Block 210).

Referring again to FIG. 3, in the context of an NTFS file system, each MFT entry 320, 330 corresponds to a file (e.g., a data file or directory) and each entry includes a collection of N attributes. To retrieve the attribute information, each entry is read and decoded to capture pertinent attribute information for each entry, which includes one or more of attributes including date, time, security, size, short file name, long file name, data runs and alternate data stream.

As shown in FIG. 2, once the attribute information is collected, it is stored so that is may be analyzed further. In several embodiments, for example, the attribute information is analyzed for indicia of pestware (Blocks 212, 214).

In conclusion, the present invention provides, among other things, a system and method for retrieving information about files stored on a file storage device. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for accessing file information from a data storage device comprising:
identifying a starting location, within the data storage device, of a file table, wherein the file table includes an entry for the file table and entries for other files stored on the data storage device;
accessing a data attribute within the entry for the file table, the data attribute including pointers to other locations where portions of the file table are stored on the data storage device;
locating, utilizing the pointers to the other locations, an entry in the file table for each of the other files; and
retrieving, relative to each entry in the file table for each of the other files, attribute information for at least one attribute of each of the other files.

2. The method of claim 1, wherein the file table is a master file table (MFT) in a new technology file system (NTFS).

3. The method of claim 1, wherein the retrieving includes retrieving information for an attribute selected from the group consisting of file name, creation date, file type, data run locations and security information.

4. The method of claim 1 including:
using the attribute information to build, in a an executable memory of a computer that uses the data storage device, a file structure for a volume of the data storage device using the attribute information.

5. The method of claim 1 including:
scanning at least a portion of data of each file for indicia of pestware;
wherein the retrieving includes retrieving information from a data run attribute of each entry in the file table so as to locate the at least a portion of data of each file.

6. The method of claim 1 including retrieving alternate data stream information from an alternate data stream attribute of each entry in the file table.

7. The method of claim 1 including locating, using the attribute information, a location of each of the other files in a directory structure of the data storage device.

8. A system for retrieving information about files stored on a data storage device of a computer comprising:
a file access module configured to identify, utilizing a file table of the files on the data storage device, locations where the file table is stored on the data storage device so as to enable attribute information for the files to be retrieved; and
a file information aggregator in communication with the file access module, wherein the file information aggregator is configured to organize and store the attribute information in an executable ;memory of the computer so as to enable the attribute information for the files to be analyzed.

9. The system of claim 8, wherein the file access module is configured to:
identify, within the data storage device, a starting location of the file table; and
access, from the file table, a data attribute within an entry for the file table, the data attribute including pointers to the locations where the file table is stored on the data storage device.

10. The system of claim 8, wherein the file table is a master file table (MFT) in a new technology file system (NTFS).

11. The system of claim 8, wherein the attribute information includes attribute information selected from the group consisting of file name, creation date, file type, data run locations and security information.

12. The system of claim 8 wherein the file information aggregator is configured to build, in a an executable memory of the computer, a file structure for a volume of the data storage device using the attribute information.

13. The system of claim 1 including a detection module configured to detect indicia of pestware by analyzing data from each of the files, wherein the data from each of the files is located utilizing the attribute information.

14. The system of claim 13 including a removal module configured to remove files showing indicia of pestware.

15. The system of claim 8, wherein the file access module is configured to retrieve alternate data stream information from an alternate data stream attribute of each entry in the file table.
